(19) United States
(12) Patent Application Publication
(10) Pub. No.: US 2016/0321645 A1
(43) Pub. Date: Nov. 3, 2016

(54) TRANSMISSION AND PROCESSING OF DATA RELATING TO A CONTACTLESS TRANSACTION

(71) Applicant: ORANGE, Paris (FR)

(72) Inventors: Halim Bendiabdallah, Vaucresson (FR); Roberto Agro, Bourg La Reine (FR); David Picquenot, Authie (FR)

(21) Appl. No.: 15/107,807

(22) PCT Filed: Dec. 22, 2014
(86) PCT No.: PCT/FR2014/053520

§ 371 Date: Jun. 23, 2016

(30) Foreign Application Priority Data
Dec. 23, 2013 (FR) 1363373

(51) Int. Cl. G06Q 20/32; G06Q 20/38; G06Q 20/40

(52) U.S. Cl. CPC G06Q 20/3278; G06Q 20/405; G06Q 20/385

(57) ABSTRACT

A method for transmitting and a method for processing data relating to a contactless transaction between a mobile terminal and an apparatus. The apparatus is capable of transmitting and receiving data via a contactless near-field communication channel. The transmission method includes: receiving first transaction data via the communication channel; transmitting the first transaction data via a communication link established with the mobile terminal; receiving, via the communication link, second transaction data generated by the mobile terminal; and transmitting the second data via the communication channel. The processing method includes receiving the first data and transmitting the second data via the communication link. A portable device and mobile terminal implementing the transmission method and the processing method are also provided.

### CROSS-REFERENCE TO RELATED APPLICATIONS

This Application is a Section 371 National Stage Application of International Application No. PCT/FR2014/053520, filed Dec. 22, 2014, the content of which is incorporated herein by reference in its entirety, and published as WO 2015/097402 on Jul. 2, 2015, not in English.

### FIELD OF THE DISCLOSURE

The present invention relates to the field of telecommunications, and more particularly to that of the performing of a transaction between a mobile terminal and a contactless terminal.

### BACKGROUND OF THE DISCLOSURE

Most existing mobile terminals make it possible, not only to establish telephone communications, but also to execute a certain number of applications downloaded into a secure module of the terminal This secure module can be a memory module of the terminal or a removable medium (for example, a UICC subscriber card, UICC standing for “Universal Integrated Circuit Card”) inserted into the terminal.

Some of these terminals are also equipped with a specific module, called “contactless module”, allowing the mobile terminal to dialogue and/or to perform contactless transactions with terminals called “contactless terminals”. More specifically, this module allows for the bidirectional transfer of data between a contactless terminal and an application previously downloaded into a secure module of the terminal. Such an application is, for example, an application in the transport field in which the passing of the mobile terminal in front of a terminal makes it possible to validate the access of the user to the transport means or a mobile payment application (the term usually employed for these applications is “mobile wallet”) which allows a user of the mobile telephone to pay for goods, bills, by means of this mobile telephone.

However, a certain number of existing mobile terminals are not equipped with a “contactless module” and it is not currently possible for the users of such terminals to benefit from the services offered by the contactless terminals.

### SUMMARY

An exemplary embodiment of the invention proposes a method for transmitting data relating to a contactless transaction between a mobile terminal and an equipment item, said equipment item being capable of transmitting and of receiving data via a contactless near field communication channel.

The transmission method is characterized in that it comprises the following steps, implemented by a portable device associated with said mobile terminal:
reception of first transaction data via said communication channel;
transmission of a first message containing said first data via a communication link established with said mobile terminal;
reception via said communication link, of a response message to said first message, said response message containing second transaction data generated as a function of said first data;
transmission of said second data via said communication channel.

The transmission method also comprises a step of obtaining, by said portable device, of a confidential code and a step of transmission of said code to the terminal or to the equipment item for validation of said transaction.

By virtue of the processing method, messages transmitted by an equipment item, such as a contactless terminal, are received by a mobile terminal and messages transmitted by a mobile terminal are received by the terminal, without requiring, for the mobile terminal, the use of communication means adapted to the communication means of the equipment item.

It is thus possible for an equipment item to communicate with a mobile terminal, even if the latter cannot establish a direct communication link with this equipment item. In particular, the equipment item and the terminal can communicate in order to perform a transaction even if the mobile terminal does not have communication means adapted to the communication means of the equipment item or if the mobile terminal is not close enough to the equipment item.

A near field communication channel, for example a communication channel of NFC type, requires the two entities to be very close to one another, approximately ten or so centimeters apart.

When the portable device is located at approximately ten or so centimeters from the equipment item or at a distance less than ten centimeters, the portable device receives messages from the equipment item and retransmits them to the mobile terminal with which it is associated. Similarly, it can relay to the equipment item the messages that it receives from the mobile terminal

Thus, the mobile terminal can communicate with the equipment item even if it is not located in the field of reception of the waves transmitted by the equipment item.

A contactless transaction can therefore take place between the mobile terminal and the equipment item without the user removing the mobile terminal from the pocket or from the bag in which it is stored. This avoids manipulation for the user and reduces the risk of theft of the mobile terminal.

The inputting of a confidential code necessary to validate certain transactions is performed in the portable device. This makes it possible to simplify the manipulations for the user and reduce the risk of theft of the mobile terminal.

According to a particular embodiment, the transmission method comprises a step of analysis of said first received data to determine whether they relate to a confidential code request and said confidential code is inserted into said first message if it is determined that the first data relate to a confidential code request.

The terminal receives the code request and the code in a same message. The confidential can thus be directly checked by the security module of the terminal. The terminal does not have to ask the user to input a confidential code. This simplifies the processing performed by this terminal.

According to another embodiment, the transmission method comprises a step of analysis of said first received data to determine whether they relate to a confidential code request and said confidential code is transmitted to said equipment item if it is determined that the first data relate to a confidential code request.

In this embodiment, the confidential code is transmitted to the equipment item without the code request reaching the terminal.

According to another embodiment of the transmission method, used alone or in combination with one of the preceding embodiments, the confidential code is obtained following a detection by said portable device of a user action signaling the agreement of said user.

The agreement of the user makes it possible to avoid having transactions performed without the knowledge of the user. This agreement makes it possible to reinforce the security of the system.

According to a particular embodiment of the data transmission method, said communication link is a Bluetooth-type link

The Bluetooth technology is a simple means for allowing two entities, approximately a meter apart, to communicate.

According to a particular embodiment of the data transmission method, said portable device is associated with said mobile terminal by a pairing procedure.

The pairing makes it possible to establish a secure link between the mobile terminal and the portable device for which the messages exchanged are encrypted.

This thus prevents any malicious entities which might obtain the messages exchanged from accessing transaction data specific to the user, for example a confidential code.

The invention relates also to a method for processing data relating to a contactless transaction between a mobile terminal and an equipment item, said equipment item being capable of transmitting and of receiving data via a contactless near field communication channel.

The processing method is characterized in that it comprises the following steps, implemented by said mobile terminal:
reception of a first message containing first transaction data, via a communication link established between said terminal and a portable device associated with said mobile terminal, said first data having been received via said communication channel;
transmission via said communication link, of a response message to said first message, said response message containing second transaction data generated by said mobile terminal as a function of said first data and intended to be transmitted by said portable device to said equipment item via said communication channel.

The mobile terminal thus receives transaction data transmitted by the equipment item, via a near field communication channel without necessarily being located in this field or without having direct reception means for data transmitted via a near field communication channel.

Second transaction data generated as a function of the received transaction data are the same as those which would have been generated if the mobile terminal and the equipment item could communicate directly via the near field communication channel.

According to a particular embodiment of the data processing method, the first received data are transferred to a security module of the mobile terminal and the second data are generated by said security module as a function of the first data.

The data messages processed by a security module are thus processed in a secure manner by an entity arranged to process these messages. The mobile terminal processes these messages in the same way as if it received them directly from the equipment item.

Thus, although the mobile terminal cannot communicate directly with the equipment item, the messages necessary to the performing of a transaction are received and transmitted by the terminal.

According to an embodiment of the data processing method, the first data are received by a first communication module of said terminal and transferred to the security module via a second contactless communication module of the mobile terminal and the second data are transmitted by the security module to said first communication module of the terminal via the second communication module of the terminal.

According to a particular feature of the processing method, the data received or transmitted by the security module conform to the SWP (Single Wire Protocol) protocol.

According to a particular embodiment of the data processing method, the first data are received by the second communication module of the terminal in a message in the HCI (Host Controller Interface) format and the second data are transmitted by said second communication module of the terminal in a message in the HCI format.

The invention relates also to a portable device associated with a mobile terminal, characterized in that it comprises:
a first communication module configured to receive, via a contactless near field communication channel, first transaction data transmitted by an equipment item and to transmit second transaction data via said communication channel;
a second communication module configured to transmit a first message containing said first data via a communication link established with said mobile terminal and to receive, via said communication link, a response message to said first message, said response message containing said second transaction data generated by said mobile terminal as a function of said first data.

According to a particular feature, the portable device comprises a user interface for controlling the stopping or the starting up of said device and/or the sending of a confidential code stored in a memory of said portable device.

The invention relates also to a mobile terminal, characterized in that it comprises a first communication module configured to:
receive a first message containing first transaction data via a communication link established between said terminal and a portable device associated with said mobile terminal, said first data having been received by said portable device via a contactless near field communication channel, and
transmit, via said communication link, a response message to said first message, said response message containing second transaction data generated by said mobile terminal as a function of said first data and intended to be transmitted by said portable device via said communication channel.

According to a particular embodiment, the mobile terminal further comprises a security module and a second communication module, said second communication module being capable of receiving and/or of transmitting data originating from and/or intended for an antenna linked to said second communication module, of communicating with the security module, of receiving first data originating from said first communication module of the terminal and of transmitting, to said first communication module of the terminal, second data generated by the security module.

The invention relates also to a contactless communication module intended to be installed in a mobile terminal comprising a first interface module for transmitting and receiving data via a contactless near field communication channel and a second interface module for communicating with a security module, characterized in that it further comprises a third interface module for receiving first data originating from a second communication module of said terminal and for transmitting second data generated by said security module to said second communication module of the terminal

The invention relates also to a computer program comprising instructions for the implementation of the method for transmitting data relating to a transaction as described previously, when this program is run by a processor.

The invention relates finally to a computer program comprising instructions for the implementation of the method for processing data relating to a transaction as described previously, when this program is run by a processor.

The invention relates also to an information medium that can be read by a data processor, and comprising instructions of a program as mentioned above. The information medium can be any entity or device capable of storing the program.

### BRIEF DESCRIPTION OF THE DRAWINGS

Other particular features and advantages of the present invention will become apparent from the following description of embodiments given as nonlimiting examples, with reference to the attached drawings, in which:

FIG. 1 is a diagram illustrating a system according to an embodiment of the invention,

FIG. 2 is a diagram illustrating a portable device capable of performing the steps of a method for transmitting data relating to a transaction according to an embodiment,

FIG. 3 is a flow diagram illustrating the different steps of a method for transmitting data relating to a transaction and a method for processing these data according to an embodiment of the invention,

FIG. 4 is a diagram illustrating a mobile terminal capable of performing the steps of a method for processing data relating to a transaction according to a first embodiment,

FIG. 5 is a flow diagram illustrating the different steps of a method for processing data relating to a transaction according to a first embodiment of the invention,

FIG. 6 is a diagram illustrating a mobile terminal capable of performing the steps of a method for processing data relating to a transaction according to a second embodiment,

FIG. 7 is a flow diagram illustrating the different steps of a method for processing data relating to a transaction according to a second embodiment of the invention.

### DETAILED DESCRIPTION OF ILLUSTRATIVE EMBODIMENTS

The invention is implemented by means of software and/or hardware components. In this respect, the term “module” can in this document correspond equally to a software component, to a hardware component or to a set of hardware and/or software components, capable of implementing a function or a set of functions, according to what is described below for the module concerned.

A software component corresponds to one or more computer programs, one or more subprograms of a program, or, more generally, to any element of a program or of software. Such a software component is stored in memory then loaded and run by a data processor of a physical entity (terminal, server, gateway, set-top-box, router, etc.) and is likely to access the hardware resources of this physical entity (memories, storage medium, communication bus, input/output electronic boards, user interfaces, etc.).

Similarly, a hardware component corresponds to any element of a hardware assembly. It can be a hardware component that is programmable or with integrated processor for the execution of software, for example an integrated circuit, a chip card, an electronic card for the execution of firmware, etc.

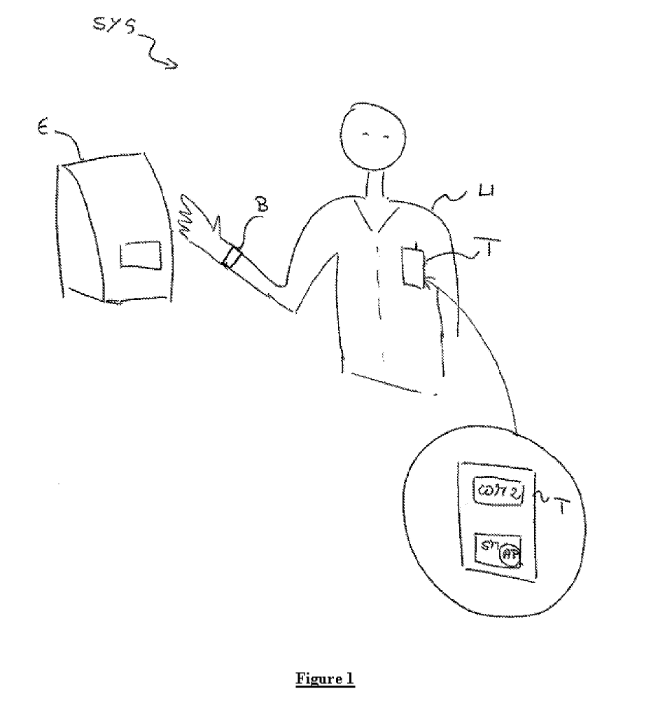

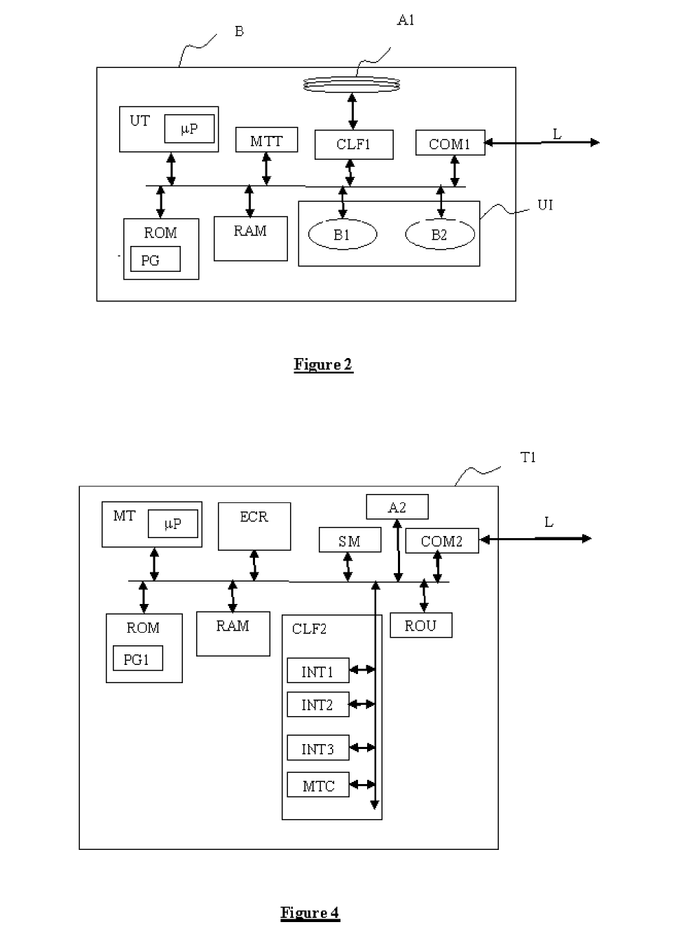

An embodiment of a method for transmitting and of a method for processing data relating to a contactless transaction will now be described with reference to FIGS. 1 and 2.

Referring to FIG. 1, a system SYS comprises a mobile terminal T of a user U, a portable device B and an equipment item E.

The equipment item E, also called “contactless terminal”, is an equipment item having a contactless module suitable for transmitting and receiving messages according to a near field communication technology, typically an NFC technology.

The mobile terminal T is, for example, a Smartphone (registered trademark).

Alternatively, the mobile terminal T is, for example, a PDA (Personal Digital Assistant).

The mobile terminal T comprises a communication module COM2 and a security module SM.

The communication module COM2 is, for example, a wireless communication module, of Bluetooth type.

The security module SM is, for example, a subscriber card of UICC (Universal Integrated Circuit Card) type.

Alternatively, the security module is a secure memory area of the mobile terminal or a removable medium of another type (for example, a subscriber card of SIM type or a memory card (SD card, Embedded Secure controller, etc.)).

One or more applications AP have been previously stored in the security module SM.

The procedure for storing an application in a security module such as the security module SM generally comprises a phase of downloading of the application from a remote server. This known procedure will not be described here.

The portable device B is, for example, a bracelet that the user installs around his wrist, or an object, for example of “key fob” type, readily accessible to the user.

FIG. 2 illustrates an example of a portable device B according to an embodiment.

The portable device B comprises a processing unit UT equipped with a microprocessor, a read-only memory of ROM type, a random access memory of RAM type.

The portable device B also comprises a first communication module CLF1 and an associated antenna A1. It also comprises a processing module MTT and a second communication module COM1.

The communication module CLF1 is a contactless near field communication module. It is suitable for communicating with the equipment item E, via the antenna A1 and via a contactless and near field communication channel C1.

As is known, a contactless near field communication between two entities requires the two entities to be approximately ten or so centimeters or less than ten centimeters apart.

The communication module CLF1 is, for example, a communication module of NFC type.

The second communication module COM1 is suitable for communicating with the communication module COM2 of the mobile terminal T via a communication link L

The second communication module COM1 of the portable device B is of Bluetooth type if the communication module COM2 of the terminal T is of Bluetooth type.

Alternatively, the second communication module COM1 of the portable device B and the communication module COM2 of the mobile terminal T are wireless communication modules of Wi-Fi type or communication modules of wired type.

The portable device B also comprises a user interface UI comprising a first button B1 and a second button B2.

The first button B1 is, for example, an “on/off” button, for example a switch, suitable for controlling the starting up or, on the contrary, the stopping of the operation of the portable device B. When it is not operating, the portable device B can neither transmit nor receive data.

The second button B2 makes it possible to control the sending, by the portable device B, via the communication module CLF1 and the communication channel C1, of a confidential code previously stored in a memory of this portable device B.

Alternatively, the portable device B does not comprise a user interface or else the user interface UI comprises only one of the buttons B1 and B2.

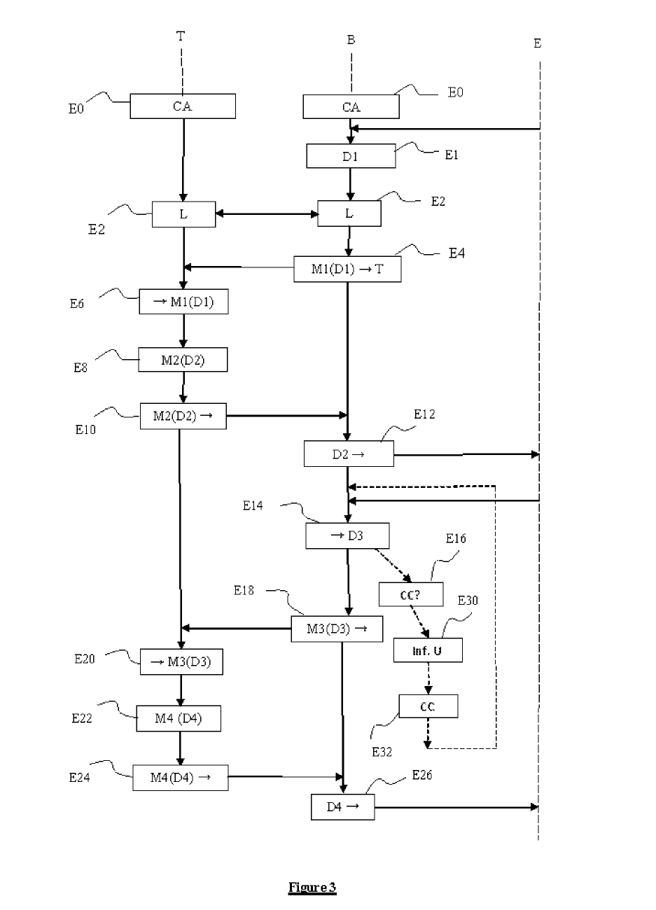

The read-only memory of ROM type comprises registers storing a computer program PG comprising program instructions suitable for implementing a method for transmitting data relating to a transaction according to an embodiment of the invention described later with reference to FIG. 3.

The main steps of a method for transmitting data relating to a contactless transaction and a method for processing data relating to a contactless transaction will now be described with reference to FIG. 3.

In a preliminary step E0, a Bluetooth pairing is carried out between the portable device B and the mobile terminal T. This pairing allows the mobile terminal T and the portable device B to communicate by a link of Bluetooth type.

The pairing comprises a generation of a pairing code CA by the portable device B and the display of this code on a screen of the portable device B. The code displayed is then input by a user of the mobile terminal T by means of a user interface of this terminal T. The pairing code CA is thus known to both entities and allows for the encryption of the data exchanged between the two entities.

In the case where the portable device B does not comprise a screen, the pairing code CA is, for example, stored in a memory of the portable device during its production and communicated to the user upon the acquisition of the portable device, for example by an attached manual.

The pairing procedure is a conventional procedure. It is performed just once. It is not necessary to repeat this procedure each time the portable device B is used or after a stoppage of operation of the device.

In a step E1, after the user U has positioned the portable device B in an environment near to the equipment item E, typically at a distance less than ten or so centimeters, the communication module CLF1 of the portable device B receives, via the antenna A1, data D1 relating to a transaction TR.

The data D1 are transmitted from the equipment item E to the portable device B via a communication channel C1.

The communication channel C1 is a contactless near field communication channel.

More specifically, the equipment item E emits a magnetic field and, when the portable device B enters into the magnetic field emitted by the equipment item E, it receives, via the antenna A1, a signal representative of the data D1 transmitted by the equipment item E. The signal received by the antenna A1 is transmitted to the communication module CLF1 which obtains the data D1 by performing a demodulation of the received signal.

The data D1 relate to a transaction TR.

The data D1 comprise, for example, a command identifier IdC and an application identifier AID of an application AP.

For example, the command identifier IdC is a SELECT identifier defined in the standard ISO 7816-4 and the data D1 make it possible to select the application AP of identifier AID out of the applications stored in the mobile terminal T.

In a step E2, a communication link L is established between the portable device B and the terminal T.

In a step E4, a message Ml containing the data D1 is constructed by the processing module MTT of the portable device B and transmitted to the mobile terminal T via the communication link L, by the second communication module COM1 of the portable device B.

The message M1 comprises, for example, the first data D1 encrypted with the pairing code CA.

The message M1 represents a first message within the meaning of the invention.

In a step E6, the message M1 is received by the communication module COM2 of the terminal T.

In a step E8, the mobile terminal T determines a response message M2 to the first message M1.

The message M2 represents a second message within the meaning of the invention.

The message M2 contains second data D2 generated by the mobile terminal T as a function of the first data D1.

The step E8 comprises the obtaining of the data D1 by decryption of the data received in the message M1 by means of the pairing code CA.

The step E8 also comprises the transmission of the first data D1 to the security module SM of the mobile terminal T, the generation by the security module SM, and more specifically by the application AP of identifier AID, of second data D2 as a function of the first data D1 and the reception from the security module SM of the second data D2.

The second data D2 are generated from information stored in the security module SM.

The second data D2 comprise, for example, information generated by the application AP indicating that the application AP has been correctly selected.

The message M2 comprises, for example, the second data D2 encrypted with the pairing code CA.

In a step E10, the response message M2 is transmitted by the communication module COM2 of the mobile terminal T, via the communication link L, to the portable device B.

The step E10 is followed by a step E12 in which the message M2 is received by the second communication module COM1 of the portable device B and the data D2 contained in the response message M2 are obtained by the processing module MTT of the portable device B and transmitted to the equipment item E, by the communication module NFC1 of the portable device B, via the antenna A1 and the communication channel C1.

Then, in a step E14 performed following the reception by the equipment item E of the data D2, the communication module CLF1 of the portable device B receives, via the antenna A1 and the communication channel C1, data D3 relating to the transaction TR.

The data D3 correspond to a command defined in the ISO 7816-4 standard.

The step E14 is followed by a step E18, in which a message M3 containing the data D3 is transmitted to the mobile terminal T, via the communication link L, by the communication module COM1 of the portable device B.

The message M3 represents a first message in the meaning of the invention.

In a step E20, the message M3 is received by the communication mode COM2 of the terminal T.

In a step E22, similar to the step E8, the mobile terminal T determines a response message M4 to the message M3.

The message M4 represents a second message in the meaning of the invention.

The message M4 contains second data D4 generated by the mobile terminal T as a function of the first data D3.

The second data D4 comprise, for example, information generated by the application AP from information stored in the mobile terminal, for example in the security module SM.

The stored information is, for example, a secret key, a counter value, etc.

The information generated is, for example, a value, received or read in a memory, encrypted with a key, a counter value computed from a stored counter value, a confidential code, etc.

In a step E24, the response message M4 is transmitted by the communication module COM2 of the terminal T to the portable device B, via the communication link L

The message M4 is a response message to the first message M3.

The step E24 is followed by a step E26 in which the response message M4 is received by the second communication module COM1 of the portable device B.

The processing module MTT of the portable device B obtains the second data D4 contained in the message M4 and the communication module NFC1 transmits the second data D4 to the equipment item E via the antenna A1 and via the communication channel C1.

As a function of the application AP, the steps E14 to E26 are optionally repeated one or more times for the transaction TR.

Alternatively, the steps E14 to E26 are not performed.

The steps E4, E12, E14, E18 and E26 implemented by the portable device B represent the steps of the method for transmitting data relating to a transaction.

The steps E6, E8, E10, E20, E20, E22 and E24 implemented by the mobile terminal T represent the steps of the method for processing data relating to a transaction.

In a first variant of the embodiment described, the step E14 of reception of first data D3 by the portable device B is followed by a step E16 in which the processing module MMT of the portable device B analyzes the data D3 received and determines whether they relate to a confidential code request.

The data D3 relate, for example, to a confidential code request if they comprise a confidential code request command identifier. If the data D3 do not relate to a confidential code request, the step E16 is followed by the step E18 described previously of sending, by the portable device B to the mobile terminal T, of a first message M3 containing the first data D3.

If the data D3 relate to a confidential code request, the step E16 is followed by a step E30 in which the processing module MTT of the portable device B informs the user U that a confidential code is required by the equipment item E.

This information is, for example, given by the display of a message on a screen of the portable device B if the portable device B is equipped with a screen or by the emission of a sound, for example a beep, by the portable device B.

The data D3 are not transmitted to the mobile terminal T.

Alternatively, the step E30 of informing of the user is performed by the equipment item E, for example by the display of a message on a screen of the equipment item E.

The step E30 is followed by a step E32 in which the processing module MTT of the portable device B obtains and transmits to the equipment item E, via the first communication module CLF1 and the communication channel C1, a confidential code CC.

The confidential code CC is, for example, prestored in a memory of the portable device B and read in this memory by the processing module MTT following the detection, by this processing module MTT, of an action of the user pressing on the second button B2.

The pressing on the second button B2 by the user is an action of the user to transmit the confidential code. In other words, this press constitutes an agreement from the user for the transaction TR. It allows the user to validate the transaction.

Alternatively, the confidential code CC is input by the user U by means of a user interface, for example a numeric keypad displayed on a screen of the portable device B, if said device is equipped with a screen.

The step E32 is followed by a new step E14 of reception, by the portable device B, of data relating to the transaction TR transmitted by the device E.

In a second variant of the embodiment described, the step E14 of reception of first data D3 by the portable device B is followed by a step E16 in which the processing module MMT of the portable device B analyzes the received data D3 and determines whether they relate to a confidential code request.

The data D3 relate, for example, to a confidential code request if they comprise a confidential code request command identifier.

If the data D3 do not relate to a confidential code request, the step E16 is followed by the step E18 described previously of sending, by the portable device B to the terminal T, of a first message M3 containing the first data D3.

If the data D3 relate to a confidential code request, the step E16 is followed by a step of obtaining of a confidential code in which the processing module MTT of the portable device B obtains a confidential code CC.

The confidential code CC is for example prestored in a memory of the portable device B and read in this memory by the processing module MTT.

The confidential code is for example read following the detection by this processing module MTT of an action of the user of pressing on the second button B2.

The pressing on the second button B2 by the user is an action of the user to allow the transmission of the confidential code. In other words, this press constitutes an agreement from the user for the transaction TR. It allows the user to validate the transaction.

Alternatively, the confidential code is read in the memory without the explicit agreement of the user.

Also, alternatively, the confidential code CC is input by the user U by means of a user interface, for example a numeric keypad displayed on a screen of the portable device B, if said device is equipped with a screen.

Then, the portable device B constructs a message containing the first data D3 and the confidential code CC and transmits the message to the terminal T.

The terminal T can thus check the confidential code.

In a third variant of the embodiment, after the user U has positioned the portable device B in an environment close to the equipment item E, a first transaction requiring the presentation of a confidential code is initialized.

Following the reception of a data message, the terminal T determines that it cannot execute the command received in the message because, on the one hand, the execution of the transaction, and consequently of this command, is subject to the presentation of a confidential code and, on the other hand, no code has been presented. The terminal T is in a “code not presented” state.

The terminal T then returns, to the equipment item E via the portable device B, a response indicating the obligation to present a confidential code.

Following the reception of this response, the equipment item E signals to the user, for example via a predefined sound signal emitted by the equipment item E, for example a beep, and/or a message displayed on a screen of this equipment item, that an input of a confidential code has to be performed.

The user moves the portable device B away from the equipment item E and initiates the sending, by the portable device B to the mobile terminal M, of a confidential code CC prestored in a memory of the portable device B.

The initiation is for example performed by the user pressing on a button, for example the button B2 or another button of the portable device B dedicated to this function.

Following the detection of the user action, the portable device B sends the prestored confidential code CC to the terminal T.

The confidential code CC is for example transmitted in a command of APDU type.

Following the reception of the confidential code, the terminal T, and more specifically the secure module of the terminal T, checks the validity of the confidential code and, if the confidential code presented is valid, is set to a “code valid” state.

The user can move the portable device B close again to perform or continue the transaction.

In a variant of this embodiment, the user commands the transmission of the confidential code to the mobile terminal M by pressing on the dedicated button before requesting the performance of a transaction, that is to say before bringing the portable device B close to the equipment item E.

To the same end, the performance of any transaction can be subject to a prior authorization from the user.

In this embodiment, the portable device B does not retransmit to the mobile terminal M the first data received from an equipment item E until it has detected an agreement from the user to perform a transaction.

This agreement is for example given by the user by pressing a specific button of the portable device.

The portable device B returns to a mode in which it does not retransmit the first data received when it detects an end of transaction or after a predefined delay.

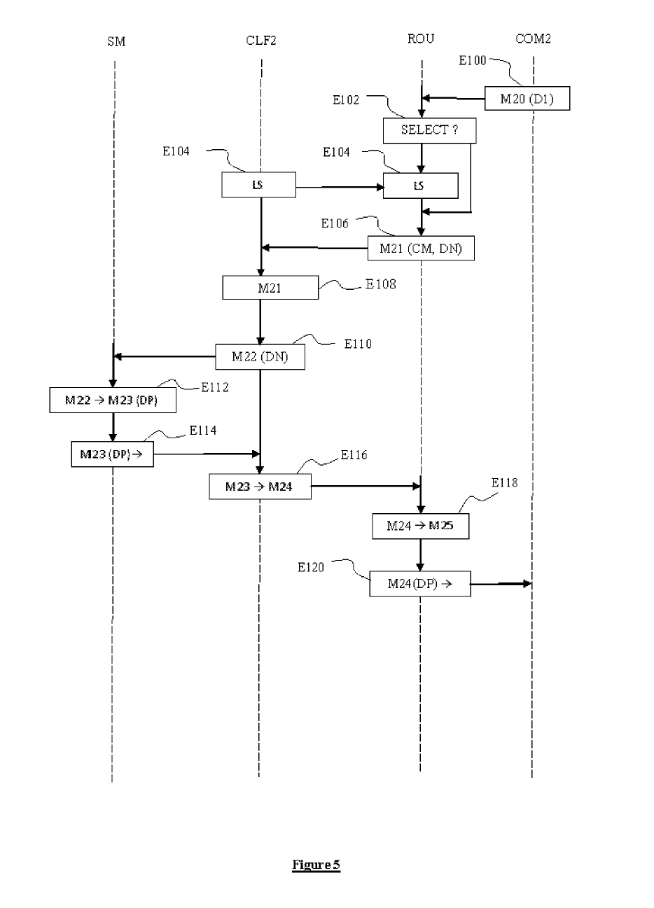

A first particular embodiment of the method for processing data relating to a transaction is described with reference to FIGS. 4 and 5.

FIG. 4 represents an example of a mobile terminal T1.

The terminal T1 comprises, as is known, notably a processing unit MT equipped with a microprocessor, a read-only memory of ROM type, a random access memory of RAM type. The terminal M1 can, conventionally and non-exhaustively, comprise the following elements: a microphone, a loudspeaker, a disk drive, a storage means, etc.

The mobile terminal T1 also comprises a secure module SM which is, for example, a subscriber card of UICC (Universal Integrated Circuit Card) type.

The mobile terminal T1 also comprises a first communication module COM2, a second communication module CLF2, an antenna and a routing module ROU.

The first communication module COM2 is a communication module capable of transmitting and of receiving data messages through a communication link for example of Bluetooth type.

Alternatively, the first communication module COM2 is suitable for wireless communication of Wi-Fi type or for communication via a wired link

The second communication module CLF2 is a contactless communication module, for example a contactless near field communication module. For example, the contactless communication module is a communication module of NFC type.

The second contactless communication module CLF2 comprises a first interface module INT1 with the antenna A2, a second interface module INT2 for the communication with the secure module SM, a third interface module INT3 with the routing module ROU of the mobile terminal T1 and a processing module MTC.

The first interface module INT1 is capable of receiving and transmitting NFC (Near Field Communication) compatible signals via the antenna A2.

The second interface module INT2 is capable of transmitting and of receiving messages from the secure module SM.

The third interface module INT3 is capable of transmitting and of receiving messages from the routing module ROU of the mobile terminal T1.

The terminal T1 can also comprise a keyboard, a display screen ECR and a display module for the display on the display screen ECR.

The read-only memory of ROM type comprises registers storing a computer program PG1 comprising program instructions suitable for implementing a method for processing data relating to a transaction according to an embodiment of the invention described later with reference to FIG. 5.

An embodiment of a method for processing data relating to a transaction implemented in the mobile terminal T1 will now be described with reference to FIG. 5.

In a preliminary step, a communication link L is established between the mobile terminal T1 and an associated portable device, for example the portable device B described with reference to FIG. 2.

In a step E100, a message M20 transmitted by the portable device B via the communication link L is received by the communication module COM2 and transferred to the routing module ROU.

The message M20 contains first data DN received from an equipment item E as described with reference to FIG. 1, via a contactless near field communication channel.

In a step E102, the routing module ROU extracts from the message M20 the first data DN and determines whether the data DN relate to a first message of a transaction TR.

The data DN relate to a first message for the transaction TR if they comprise, for example, an application selection command, for example a command of SELECT type defined in the ISO 7816-4 standard.

If the data DN relate to a first message for the transaction TR, the routing module ROU of the mobile terminal T1 establishes, in a step E104, a communication link LS with the second communication module CLF2. The communication link LS is for example a serial link

If the data DN do not relate to a first message for the transaction TR, a communication link LS being already established between the routing module ROU and the second communication module CLF2 and the step E102 is followed by a step E106.

In a step E106, following the step E102 or the step E104, the routing module ROU of the mobile terminal T1 constructs a message M21 containing the first data D1 and transmits the constructed message M21 to the second communication module CLF2 via the serial link LS.

The message M21 is for example a message in the HCI (Host Controller Interface) format. The HCI format is for example described in the ETSI standard TS 102 622.

The message M21 is for example an HCI command comprising a command value CM and the first data D1. For example, the first data D1 are encapsulated in the message M21.

The message M21 is for example an HCI command of “EVT-SEND-DATA” type.

The step E106 is followed by a step E108 in which the message M21 is received by the third interface module INT3 of the contactless module CLF2 and transmitted to the processing module MTC of the second contactless module CLF2.

In a step E110, the processing module MTC determines, for example by extraction of the command value CM from the message M21, that the data contained in the message M21 originate from the routing module ROU of the mobile terminal T1 via the serial communication link LS, and transforms the message M21 into a message M22.

The message M22 is for example a message in the SWP (Single Wire Protocol) format. The ETSI standard TS 102 613 defines the SWP protocol used for the communication between a contactless communication module of NFC type and a security module, such as the security module SM.

The message M22 is a message containing the first data D1 received in the message M20.

The message M22 is transmitted by the processing module MTC of the second communication module CLF2 to the security module SM via the second interface module INT2.

In a step E112, following the reception of the message M22, the security module SM, and more particularly the application AP selected for the current transaction TR, processes the message M22 received and generates second transaction data DP as a function of the first data DN and constructs a response message M23 containing the second data generated D2.

The second data DP are for example generated as a function of information stored in the security module SM.

The response message M23 is for example a message in the SWP format.

The message M23 is transmitted by the security module SM to the processing module MTC of the communication module CLF2, via the second interface module INT2 of the contactless communication module CLF2 in a step E114.

Then, in a step E116, the processing module MCT of the second communication module CLF2 constructs a message M24 and transmits it to the routing module ROU of the mobile terminal T1 via the third interface module INT3 and the serial communication link LS.

The message M24 is for example a message in the HCI format and is obtained by adapting the message M23 to the HCI format. The message M24 contains the second data DP.

In a step E118, the routing module ROU of the mobile terminal T1 receives the message M24 and converts it into a message M25.

The message M25 is for example obtained by extraction of the second transaction data DP from the message M24 and by encryption of the second data D2 with a pairing code CA shared by the mobile terminal T and the portable device B.

In a step E120, the message M25 is transmitted by the first communication module COM2 to the portable device B, via the communication link L established between the mobile terminal T1 and the portable device B.

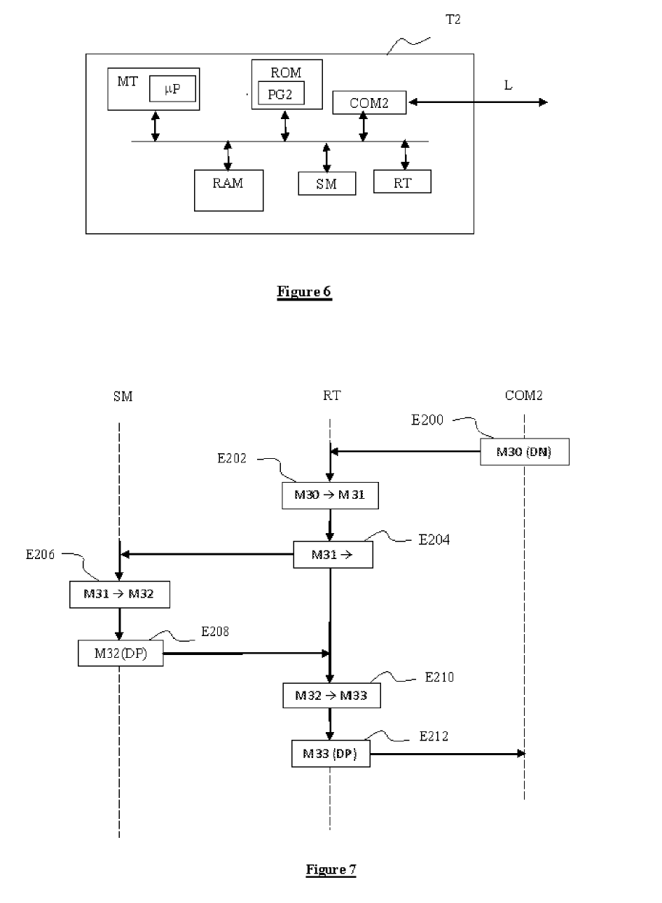

A second particular embodiment of the data processing method is described with reference to FIGS. 6 and 7.

FIG. 6 represents an example of a mobile terminal T2.

The terminal T2 comprises, as is known, notably a processing unit MT equipped with a microprocessor, a read-only memory of ROM type, a random access memory of RAM type. The terminal T2 can comprise, conventionally and non-exhaustively, the following elements: a keyboard, a display screen, a display module for display on the display screen, a microphone, a loudspeaker, a disk drive, a storage means, etc.

The mobile terminal T2 also comprises a secure module SM which is, for example, a subscriber card of UICC (Universal Integrated Circuit Card) type.

The mobile terminal T2 also comprises a communication module COM2 and a routing module RT.

The communication module COM2 is a communication module capable of transmitting and receiving data messages through a communication link of Bluetooth type for example.

Alternatively, the communication module COM2 is suitable for wireless communication, for example of Wi-Fi type, or for communication via a wired link

The read-only memory of ROM type comprises registers storing a computer program PG2 comprising program instructions suitable for implementing a method for processing data relating to a transaction according to an embodiment of the invention described later with reference to FIG. 7.

An embodiment of a method for processing data relating to a transaction TR, implemented in the mobile terminal T2, will now be described with reference to FIG. 7.

In a preliminary step, a communication link L is established between the mobile terminal T2 and an associated portable device for example the portable device B described with reference to FIG. 2.

In a step E200, a message M30 transmitted by the portable device B via the communication link L is received by the communication module COM2 and transferred to the routing module RT of the mobile terminal T2.

The message M30 contains first data DN received from an equipment item E as described with reference to FIG. 1, via a contactless near field communication channel.

In a step E202, the routing module RT constructs a message M31 containing the first data DN contained in the message M30.

For example, the routing module RT obtains the first data DN by decryption of the message M30 using a pairing key shared by the mobile terminal T2 and the associated portable device B and encapsulates the duly obtained first data DN in a message M31 in the SWP format.

The step E202 is followed by a step E204 in which the message M31 is transmitted by the routing module RT of the mobile terminal T2 to the security module SM.

In a step E206, following the reception of the message M31, the security module SM, and more particularly the application AP selected for the current transaction TR, processes the received message M31 and generates second transaction data DP as a function of the first data DN and constructs a response message M32 containing the generated second data DN.

The second data DP are for example generated as a function of information stored in the security module SM.

The response message M32 is a message in the SWP format.

The message M32 is transmitted by the security module SM to the routing module RT of the mobile terminal T2 in a step E208.

In a step E210, the routing module RT of the mobile terminal T2 converts the received message M32 into a message M33.

The message M33 is for example obtained by extraction of the second transaction data DP from the message M32 then by encryption of the second data DP with the pairing key of the link established between the mobile terminal T2 and the portable device B.

The message M33 is transmitted via the communication module COM2 and the communication link L to the portable device B in a step E212.

An exemplary embodiment of the invention remedies inadequacies/drawbacks of the prior art and/or provides improvements thereto.

Although the present disclosure has been described with reference to one or more examples, workers skilled in the art will recognize that changes may be made in form and detail without departing from the scope of the disclosure and/or the appended claims.

1. A method for transmitting data relating to a contactless transaction between a mobile terminal and an equipment item, said equipment item being capable of transmitting and of receiving data via a contactless near field communication channel, the method comprising the following steps acts, implemented by a portable device associated with said mobile terminal:
reception of first transaction data via said communication channel;
transmission of a first message containing said first data via a communication link established with said mobile terminal;
reception via said communication link, of a response message to said first message, said response message containing second transaction data generated by said mobile terminal as a function of said first data;
transmission of said second data via said communication channel, wherein the transmission comprises obtaining, by said portable device, a confidential code and transmission of said code to the terminal or to the equipment item for validation of said transaction.

2. The method as claimed in claim 1 wherein the method comprises analysis of said first received data to determine whether they relate to a confidential code request and in which said confidential code is inserted into said first message if it is determined that the first data relate to a confidential code request.

3. The method as claimed in claim 1 wherein the method comprises analysis of said first received data to determine whether they relate to a confidential code request and in which said confidential code is transmitted to said equipment item if it is determined that the first data relate to a confidential code request.

4. The method as claimed in claim 1, in which the confidential code is obtained following a detection by said portable device of a user action signaling the agreement of said user.

5. The method claimed in claim 1, in which said communication link is a Bluetooth-type link.

6. The method as claimed in claim 1, in which said portable device is associated with said mobile terminal by a pairing procedure.

7. (canceled)

8. (canceled)

9. (canceled)

10. (canceled)

11. A portable device associated with a mobile terminal, wherein the portable device comprises:
a first communication module configured to receive, via a contactless near field communication channel, first transaction data transmitted by an equipment item and to transmit second transaction data via said communication channel; and
a second communication module configured to transmit a first message containing said first data via a communication link established with said mobile terminal and to receive, via said communication link, a response message to said first message, said response message containing said second transaction data generated by said mobile terminal as a function of said first data.

12. The portable device as claimed in claim 12, wherein the portable device comprises a user interface for controlling the stopping or the starting up of said portable device and/or a sending of a confidential code stored in a memory of said portable device.

13. A mobile terminal, wherein the mobile terminal comprises:
a first communication module configured to:
receive a first message containing first transaction data via a communication link established between said terminal and a portable device associated with said mobile terminal, said first data having been received by said portable device via a contactless near field communication channel, and
transmit, via said communication link, a response message to said first message, said response message containing second transaction data generated by said mobile terminal as a function of said first data and intended to be transmitted by said portable device via said communication channel.

14. The mobile terminal as claimed in claim 13, wherein the mobile terminal further comprises a security module and a second communication module, said second communication module being configure to receive and/or transmit data originating from and/or sent to an antenna linked to said second communication module, communicate with the security module, receive first data originating from said first communication module of the terminal and transmit, to said first communication module of the terminal, second data generated by the security module.

15. (canceled)

16. A non-transitory computer-readable medium comprising a computer program stored thereon, comprising instructions for implementing a method for transmitting data relating to a contactless transaction between a mobile terminal and an equipment item, when this program is run by a processor of a portable device associated with said mobile terminal, said equipment item being capable of transmitting and of receiving data via a contactless near field communication channel, wherein the program configured the portable device to perform acts of:
receiving first transaction data via said communication channel;
transmitting a first message containing said first data via a communication link established with said mobile terminal;
receiving via said communication link, a response message to said first message, said response message containing second transaction data generated by said mobile terminal as a function of said first data;
transmitting said second data via said communication channel, wherein transmitting comprises obtaining, by said portable device, a confidential code and transmitting said code to the terminal or to the equipment item for validation of said transaction.

17. (canceled)
